(19) United States
(12) Patent Application Publication
(10) Pub. No.: US 2003/0120518 A1
(43) Pub. Date: Jun. 26, 2003

(54) Method for providing an insured result for section 1031 exchanges

(76) Inventor: John R. Galley, Saint George, ME (US)

Correspondence Address: PATRICK R. SCANLON, PIERCE ATWOOD, ONE MONUMENT SQUARE, PORTLAND, ME, 04101, US

(21) Appl. No.: 10/034,558

(22) Filed: Dec. 26, 2001

(51) Int. Cl. G06F 17/60

(52) U.S. Cl. 705/4; 705/31

(57) ABSTRACT

A method for providing an insured result for a Section 1031 exchange includes the steps of qualifying a taxpayer for insurance coverage, insuring the taxpayer against the Section 1031 exchange being disallowed; and providing a payment to the taxpayer if the Section 1031 exchange is disallowed. In one embodiment, the step of qualifying the taxpayer includes obtaining information relating to the Section 1031 exchange, preferably in affidavit form. The insurance payment can be conditioned on the veracity and completeness of information provided by the taxpayer.

### BACKGROUND OF THE INVENTION

This invention relates generally to tax deferred exchanges under Section 1031 of the Internal Revenue Code and more particularly to a method for insuring successful Section 1031 exchanges.

Under U.S. tax laws, individual and corporate taxpayers must pay taxes on capital gains. That is, when a capital asset (such as stocks, bonds and real estate) is sold for a profit, a tax must be paid on the capital gain. A capital gain is the difference between the amount a capital asset is sold for and the basis, which is usually the amount paid for the asset, although the basis is determined differently for capital assets received as a gift or inheritance. If a capital asset is sold for less than the basis (i.e., a capital loss), no capital gains tax is assessed.

Section 1031 of the Internal Revenue Code provides tax deferred capital gains treatment to taxpayers who exchange (rather than sell) selected categories of property held for investment or business purposes for other like-kind property. Section 1031 has been part of the tax code since 1929. For decades, Section 1031 exchanges were simultaneous. That is, the taxpayer's divested asset (commonly referred to as the relinquished property) and the acquired asset (commonly referred to as the replacement property) were transferred at the same time.

In 1979, the U.S. Court of Appeals for the Ninth Circuit issued a landmark decision in Starker v. United States, 602 F.2d 1341 (9th Cir. 1979) that reinterpreted Section 1031. The Starker case permitted an expanded time envelope where the relinquished property was transferred initially and the replacement property was transferred at a later date, thus giving rise to the so-called “deferred exchange.” This more user friendly approach greatly expanded the practical desirability and feasibility of Section 1031 exchanges, leading to greater usage of exchanges.

The Starker case holdings were codified by the Tax Act of 1984, further paving the way for increased usage of Section 1031 exchanges. Then in 1991, the Internal Revenue Service (IRS) issued Deferred Exchange Regulations that provided clarification and guidance on performing deferred exchanges under Section 1031. The regulations also created “safe harbors” that taxpayers could rely on to ensure compliance with Section 1031. One of these safe harbors is the use of a “qualified intermediary.” A qualified intermediary is an arm's length third party that enters into a written exchange agreement with the taxpayer and, as required by the exchange agreement, acquires the relinquished property from the taxpayer, transfers the relinquished property, acquires the replacement property, and transfers the replacement property to the taxpayer. In each transfer, the owner can deed directly to the buyer, but the qualified intermediary handles the money. The taxpayer cannot have actual or constructive receipt of the proceeds from the transfer of the relinquished property until the transfer of the replacement property.

Despite being unambiguously approved in the Tax Code, Section 1031 exchanges have been viewed by the general taxpaying public as being an aggressive tax avoidance technique. Quite often, any technique that results in tax deferral or avoidance is perceived as being “too good to be true.” This perception, coupled with the public's inherent fear of the IRS, has the practical result of causing many taxpayers to forgo Section 1031 exchanges. Thus, many legitimate, mainstream candidates to utilize Section 1031 exchanges end up paying unnecessary taxes.

Accordingly, there is a need for a process for encouraging proper use of Section 1031 exchanges by alleviating taxpayer's fears about the technique.

### SUMMARY OF THE INVENTION

The above-mentioned need is met by the present invention, which includes a method for providing an insured result for a Section 1031 exchange. The method includes the steps of qualifying a taxpayer for insurance coverage, insuring the taxpayer against the Section 1031 exchange being disallowed; and providing a payment to the taxpayer if the Section 1031 exchange is disallowed. In one embodiment, the step of qualifying the taxpayer includes obtaining information relating to the Section 1031 exchange, preferably in affidavit form. The insurance payment can be conditioned on the veracity and completeness of information provided by the taxpayer.

The present invention and its advantages over the prior art will become apparent upon reading the following detailed description and the appended claims with reference to the accompanying drawings.

### DESCRIPTION OF THE DRAWINGS

The subject matter that is regarded as the invention is particularly pointed out and distinctly claimed in the concluding part of the specification. The invention, however, may be best understood by reference to the following description taken in conjunction with the accompanying drawings in which:

FIG. 1 is a flowchart depicting a process for providing an insured result for a Section 1031 exchange.

FIG. 2 is a flowchart depicting an alternative process for providing an insured result for a Section 1031 exchange.

### DETAILED DESCRIPTION OF THE INVENTION

The present invention relates to methods for providing an “exchange insured result” intended to alleviate taxpayer concerns and encourage use of Section 1031 exchanges by providing taxpayers with the overwhelming comfort of a guaranteed, insured tax deferred result. A core concept of the method is insuring taxpayers against Section 1031 exchanges being disallowed. The insurance can be provided by a qualified intermediary facilitating the Section 1031 exchange or by a separate insurance carrier. As used herein, the term “Section 1031 exchange” refers to any exchange of property pursuant to Section 1031 of the Internal Revenue Code (26 U.S.C. §1031). Section 1031 sets forth that no gain or loss shall be recognized on the exchange of property held for productive use in a trade or business or for investment if such property is exchanged solely for property of like kind which is to be held either for productive use in a trade or business or for investment. The present invention is most applicable to deferred exchanges under Section 1031, but is not so limited. The term “Section 1031 exchange” is also intended to encompass property exchanges made pursuant to Section 1031 as it may be amended in the future and any property exchanges made pursuant to any future statutes, regulations or rules that may come to exist either in place of or in addition to Section 1031.

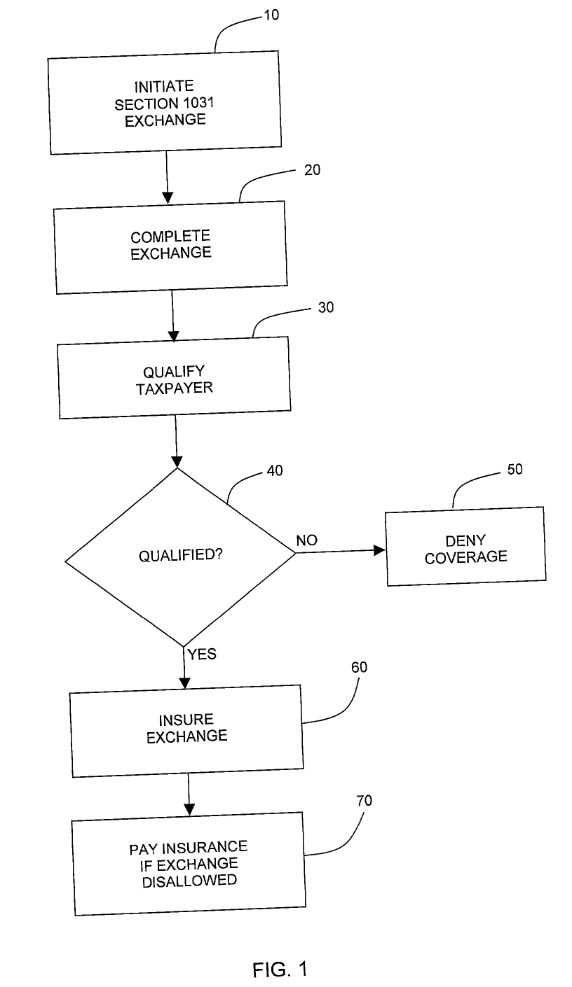

Referring to FIG. 1, a method for providing an insured result for a Section 1031 exchange is depicted in the form of a flowchart. The method starts at block 10 wherein a Section 1031 exchange is initiated by, or on behalf of, a taxpayer. The Section 1031 exchange can be begun on the taxpayer's own initiative or on the advice of the taxpayer's attorney, accountant or other advisor. Generally, the taxpayer identifies an appropriate piece of property he or she desires to exchange for another like-kind property. Section 1031 currently covers property held for productive use in a trade or business or for investment and does not apply to certain enumerated classes of property such as stocks, bonds, or notes. At some point in the process, a like-kind replacement property is also identified.

Initiation of the Section 1031 exchange also includes the taxpayer retaining a qualified intermediary. Although use of a qualified intermediary is not a statutory requirement, the present invention is primarily concerned with Section 1031 exchanges in which the services of a qualified intermediary are employed. The qualified intermediary must be an arm's length third party and cannot have acted as the taxpayer's employee, attorney, accountant, investment banker or broker, or real estate agent or broker within the 2-year period ending on the transfer date of the relinquished property. The taxpayer and qualified intermediary enter into a written exchange agreement. The qualified intermediary, usually for a fee, agrees to acquire the relinquished property from the taxpayer, transfer the relinquished property to a buyer, acquire the replacement property from a seller, and transfer the replacement property to the taxpayer.

Next, the Section 1031 exchange is completed at block 20. This proceeds in typical fashion with the qualified intermediary coordinating: (1) the transfer of the relinquished property from the taxpayer to the buyer, and (2) the transfer of the replacement property from the seller to the taxpayer. Each of these two transfers generally occurs in typical fashion, such as at a closing at a title company. However, the taxpayer cannot have actual or constructive receipt of the proceeds from the transfer of the relinquished property until the transfer of the replacement property. Thus, the qualified intermediary handles these proceeds; typically, this money is wire transferred to the intermediary's trustee bank during the closing.

As mentioned above, a primary aspect of the present invention is to provide the taxpayer with insurance against the Section 1031 exchange being disallowed by the IRS. However, this “exchange insured result” concept is not intended to be an avenue for taxpayers with “gray area” exchanges to obtain a satisfactory result by acquiring this insurance coverage. Consequently, the next step of the process is to qualify the taxpayer as indicated at block 30. Only taxpayers seeking exchanges clearly falling within the intent of the Tax Code will qualify for the insurance coverage.

Taxpayer qualification includes obtaining pertinent information relating to the Section 1031 exchange from the taxpayer. One approach for obtaining the information is to require the taxpayer to complete a questionnaire. The questionnaire would be designed to determine whether the proposed exchange falls within the four corners of Section 1031 and meets appropriate exchange safe harbors. As used herein, the term “exchange safe harbors” refers to the safe harbors set forth in the 1991 Deferred Exchange Regulations (26 CFR 1.1031(k)-1) issued by the IRS and is also intended to encompass any future amendments to 26 CFR 1.1031(k)-1 and any future statutes, regulations or rules that may come to exist either in place of or in addition to 26 CFR 1.1031(k)-1. The questionnaire would include a series of questions about the taxpayer and the relinquished property. This would include questions relating to how the property was used, the nature of the property, and how long the taxpayer has held the property. There would also be questions about how the taxpayer completed the exchange, including questions pertaining to the nature, value and intended use of the replacement property.

Another aspect is that the questionnaire is in affidavit form or is otherwise required to be verified by the taxpayer. Moreover, the questionnaire can indicate that insurance coverage will be conditioned on the completeness and veracity of the information provided. That is, pursuant to the form of the affidavit and the terms of coverage, any incomplete, misleading or false information provided by the taxpayer will render any insurance coverage null and void.

Once collected via the questionnaire, the information is reviewed to determine if the taxpayer's exchange will qualify for insurance coverage as indicated at block 40. This review can be done by the qualified intermediary and/or the outside insurance carrier, if one is used. If the taxpayer does not qualify, then insurance coverage is denied as indicated at block 50. At this point, the process would end.

If the taxpayer does qualify, then insurance coverage is provided as indicated at block 60. As mentioned above, this coverage insures the taxpayer against the Section 1031 exchange being disallowed. The qualified intermediary can provide the insurance directly or can obtain insurance underwriting from an insurance carrier. In one possible embodiment, the qualified intermediary or insurance carrier provides a specific, individualized policy to each taxpayer. In an alternative embodiment, the insurance carrier provides the actual insurance coverage to the qualified intermediary. Any qualifying taxpayer then becomes a beneficiary and is issued a certificate of indemnification from the qualified intermediary. The certificate of indemnification indicates that the taxpayer is an authorized beneficiary and is essentially a promise that the taxpayer will receive an appropriate payment in the event the Section 1031 exchange is disallowed.

The IRS may audit the taxpayer after the Section 1031 exchange is completed. If the IRS disallows the insured Section 1031 exchange, then the taxpayer is provided with a payment under the terms of the insurance coverage as indicated at block 70. This payment would include all tax, penalty and interest assessed as a result of the taxpayer's Section 1031 exchange being disallowed. Alternatively, the payment could be just a portion of the assessed tax, penalty and interest, such as the penalty and interest. The payment could also be conditioned on the insurance carrier exhausting all possible appeals if the IRS disallows the insured Section 1031 exchange. That is, the insurance carrier would have the option of appealing a negative IRS ruling prior to making the insurance payment to the taxpayer. If all possible appeals are ultimately denied, then the payment is made to the taxpayer.

In the method shown in FIG. 1, taxpayer qualification occurs after the Section 1031 exchanged has been completed. One reason for this is the fact that much of the information needed in completing the questionnaire will not be known until the exchange is completed. However, the present invention is not limited to a particular sequence of events. In some circumstances (e.g., where the taxpayer knows all pertinent information relating to a Section 1031 exchange prior to completing the exchange), it is possible to conduct taxpayer qualification and insure an exchange prior to the Section 1031 exchange being completed.

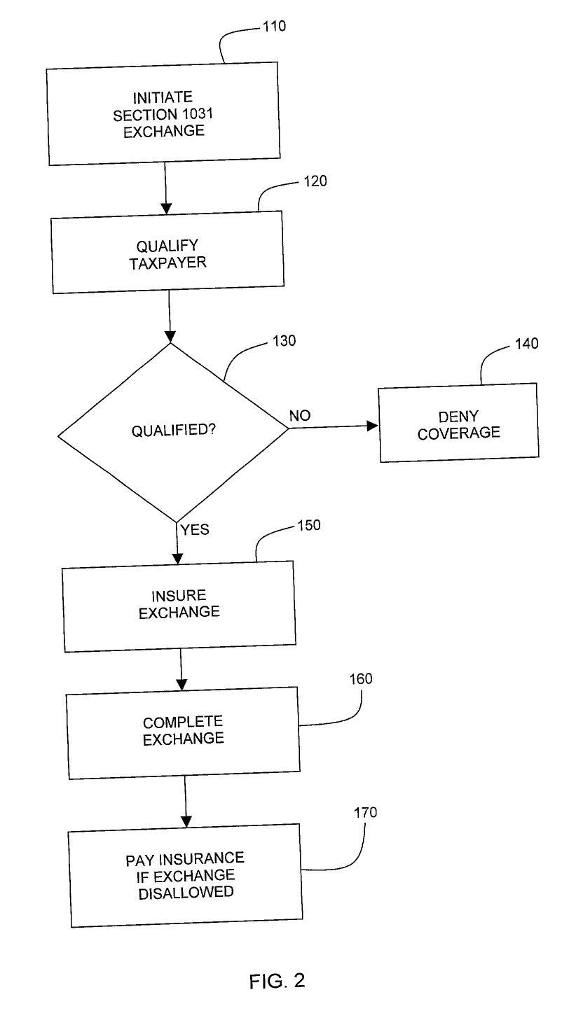

Referring to FIG. 2, one such alternative method for providing an insured result for a Section 1031 exchange is depicted in the form of a flowchart. The method starts at block 110 wherein a Section 1031 exchange is initiated by, or on behalf of, a taxpayer in the same manner as described above. The next step of the process is to qualify the taxpayer, as indicated at block 120, so that only taxpayers seeking exchanges clearly falling within the intent of the Tax Code will qualify for the insurance coverage. Similar to the process described above in connection with FIG. 1, taxpayer qualification includes obtaining pertinent information relating to the Section 1031 exchange from the taxpayer, particularly through use of a questionnaire in affidavit form.

The collected information is reviewed to determine if the taxpayer's exchange will qualify for insurance coverage as indicated at block 130. This review can be done by the qualified intermediary and/or the outside insurance carrier, if one is used. If the taxpayer does not qualify, then insurance coverage is denied as indicated at block 140. At this point, the process would end, although it is possible that the taxpayer and the qualified intermediary could proceed with the Section 1031 exchange in a traditional manner without insurance coverage.

If the taxpayer does qualify, then insurance coverage is provided, in the same manner as described above, as indicated at block 150. This gives the taxpayer the assurance of a guaranteed, insured tax deferred result before the taxpayer completes the exchange. Next, the Section 1031 exchange is completed in typical fashion at block 160. Then, if the IRS subsequently disallows the insured Section 1031 exchange, the taxpayer is provided with a payment under the terms of the insurance coverage as indicated at block 170. The terms and conditions of this payment are the same as those described above in connection with FIG. 1.

The foregoing has described a method for providing an insured result for Section 1031 exchanges and thereby encourages proper use of Section 1031 exchanges. This supports the desirable public policy goal that all taxpayers be encouraged to avail themselves of any benefit provided by the Tax Code. While specific embodiments of the present invention have been described, it will be apparent to those skilled in the art that various modifications thereto can be made without departing from the spirit and scope of the invention as defined in the appended claims.

What is claimed is:

1. A method for providing an insured result for a Section 1031 exchange, said method comprising providing a taxpayer with insurance that at least a portion of any tax, penalty and interest assessed as a result of said taxpayer's Section 1031 exchange being disallowed will be paid to said taxpayer.

2. The method of claim 1 further comprising qualifying said taxpayer for insurance coverage by obtaining information relating to said Section 1031 exchange.

3. The method of claim 2 wherein said information includes information pertaining to the properties to be exchanged under said Section 1031 exchange.

4. The method of claim 2 further comprising requiring said taxpayer to provide information relating to said Section 1031 exchange in affidavit form.

5. The method of claim 4 further comprising conditioning payment of said insurance on the veracity and completeness of information provided by said taxpayer.

6. The method of claim 1 wherein qualifying a taxpayer for insurance coverage includes determining that said Section 1031 exchange meets applicable exchange safe harbors.

7. The method of claim 1 wherein insuring said taxpayer against said Section 1031 exchange being disallowed includes obtaining insurance underwriting from an insurance carrier.

8. The method of claim 7 wherein insuring said taxpayer against said Section 1031 exchange being disallowed includes providing said taxpayer with a certificate of indemnification.

9. A method for providing an insured result for a Section 1031 exchange, said method comprising:
qualifying a taxpayer for insurance coverage;
insuring said taxpayer against said Section 1031 exchange being disallowed; and
providing a payment to said taxpayer if said Section 1031 exchange is disallowed.

10. The method of claim 9 wherein said payment includes at least a portion of any tax, penalty and interest assessed as a result of said taxpayer's Section 1031 exchange being disallowed.

11. The method of claim 9 wherein qualifying a taxpayer for insurance coverage includes obtaining information relating to said Section 1031 exchange.

12. The method of claim 11 wherein said information includes information pertaining to the properties to be exchanged under said Section 1031 exchange.

13. The method of claim 11 further comprising requiring said taxpayer to provide information relating to said Section 1031 exchange in affidavit form.

14. The method of claim 13 further comprising conditioning said payment on the veracity and completeness of information provided by said taxpayer.

15. The method of claim 9 wherein qualifying a taxpayer for insurance coverage includes determining that said Section 1031 exchange meets applicable exchange safe harbors.

16. The method of claim 9 wherein insuring said taxpayer against said Section 1031 exchange being disallowed includes obtaining insurance underwriting from an insurance carrier.

17. The method of claim 16 wherein insuring said taxpayer against said Section 1031 exchange being disallowed includes providing said taxpayer with a certificate of indemnification.

18. A method of facilitating a Section 1031 exchange for a taxpayer, said method comprising:
serving as a qualified intermediary for said Section 1031 exchange;
insuring said taxpayer against said Section 1031 exchange being disallowed by the Internal Revenue Service; and
providing a payment to said taxpayer if the Internal Revenue Service disallows said Section 1031 exchange.

19. The method of claim 18 further comprising qualifying said taxpayer for insurance coverage by obtaining information relating to said Section 1031 exchange.

20. The method of claim 19 wherein said information includes information pertaining to the properties to be exchanged under said Section 1031 exchange.

21. The method of claim 19 further comprising requiring said taxpayer to provide information relating to said Section 1031 exchange in affidavit form.

22. The method of claim 21 further comprising conditioning said payment on the veracity and completeness of information provided by said taxpayer.

23. The method of claim 18 wherein qualifying a taxpayer for insurance coverage includes determining that said Section 1031 exchange meets applicable exchange safe harbors.

24. The method of claim 18 wherein insuring said taxpayer against said Section 1031 exchange being disallowed includes obtaining insurance underwriting from an insurance carrier.

25. The method of claim 24 wherein insuring said taxpayer against said Section 1031 exchange being disallowed includes providing said taxpayer with a certificate of indemnification.
